(19) United States
(12) Patent Application Publication
(10) Pub. No.: US 2025/0363416 A1
(43) Pub. Date: Nov. 27, 2025

(54) METHOD FOR IMPROVING SYNTHETIC GROUND TRUTH DATA

(71) Applicant: Robert Bosch GmbH, Stuttgart (DE)

(72) Inventors: Bernd Goebelsmann, Bad Salzdetfurth (DE); Dennis Mack, Sibbesse (DE); Dirk Fortmeier, Hildesheim (DE); Jochen Kall, Hildesheim (DE)

(21) Appl. No.: 19/172,704

(22) Filed: Apr. 8, 2025

(30) Foreign Application Priority Data
Apr. 10, 2024 (DE) 10 2024 203 267.0

(51) Int. Cl. G06N 20/00

(52) U.S. Cl. CPC G06N 20/00

(57) ABSTRACT

Method and apparatus for improving synthetic ground truth data by means of a data generator and for training a target machine learning model. The method includes: providing ground truth data samples which relate to ground truth source data and are synthetically generated by the data generator; comparing a performance of the data generator for the provided ground truth data samples with a performance threshold value; generating anew ground truth data samples for the same ground truth source data by means of the data generator if the performance threshold value for the provided ground truth data samples is not achieved; replacing the ground truth data samples for which the performance threshold value is not achieved with the newly generated ground truth data samples; and training the target machine learning model on the basis of the replaced and provided ground truth data samples.

### FIELD

The present invention relates to a method and an apparatus for improving synthetic ground truth data by means of a data generator and for training a target machine learning model.

### BACKGROUND INFORMATION

In the world of artificial intelligence (AI), the focus of interest is on the quality and diversity of training data. To maximize the performance capability of AI networks, it is critical that they be trained with a broad range of data that covers both real and unforeseen situations. For reasons of cost and the need to also take into account rare events (corner cases) in training data sets, researchers and developers are increasingly turning to synthetic data. Traditionally, such data is created by modeling scenes as 3D models, and then randomizing these models and generating images using ray tracing or rasterizing. Even though this method can be effective, it has its limitations. The quality of the thus created data can therefore be limited. The method may also not scale well, which, in particular given the growing demands of AI development, is problematic.

In response to these challenges, there has been a paradigm shift in the creation of training data. Traditional methods are increasingly being replaced by AI-supported methods, in which AI models themselves are used to create ground truth data from existing ground truth target data. This new approach provides the ability to generate data with unprecedented diversity and on a large scale. It also entails uncertainties with respect to data quality, however, because AI-generated data cannot provide the same quality assurances as conventionally created data. Added to this is the problem that, because of the volume of data generated, manual quality control is not a practical solution.

It is an object of the present invention to provide an improved method and/or an improved apparatus.

The object may be achieved by a method according to certain features of the present invention.

### SUMMARY

According to a first aspect of the present invention, a method for improving synthetic ground truth data by means of a data generator and for training a target machine learning model is provided. According to an example embodiment of the present invention, the method comprises the steps:
providing ground truth data samples which relate to ground truth source data and are synthetically generated by the data generator;
comparing a performance of the data generator for the provided ground truth data samples with a performance threshold value;
generating anew ground truth data samples for the same ground truth source data by means of the data generator if the performance threshold value for the provided ground truth data samples is not achieved;
replacing the ground truth data samples for which the performance threshold value is not achieved with the newly generated ground truth data samples; and
training the target machine learning model on the basis of the replaced and provided ground truth data samples.

It goes without saying that the steps according to the present invention and other optional steps do not necessarily have to be carried out in the order shown, but can also be carried out in a different order. Other intermediate steps can moreover be provided as well. The individual steps can also include one or more substeps without departing from the scope of the method according to the invention.

According to a second aspect of the present invention, an apparatus for improving synthetic ground truth data by means of a data generator and for training a target machine learning model is provided. According to an example embodiment of the present invention, the apparatus comprises an evaluation and computing device which is configured to carry out the following steps:
providing ground truth data samples which relate to ground truth source data and are synthetically generated by the data generator;
comparing a performance of the data generator for the provided ground truth data samples with a performance threshold value;
generating anew ground truth data samples for the same ground truth source data by means of the data generator if the performance threshold value for the provided ground truth data samples is not achieved;
replacing the ground truth data samples for which the performance threshold value is not achieved with the newly generated ground truth data samples; and
training the target machine learning model on the basis of the replaced and provided ground truth data samples.

When “providing synthetic ground truth data”, the data generator generates synthetic ground truth data samples. These data serve as the basis or “ground truth” for training the target machine learning model. For instance, they are initial attempts to replicate reality or the properties of real data sets. The performance or quality of this generated data is then evaluated by comparing it with a predefined performance standard or performance threshold value. This check is intended to ensure that the generated data have a certain quality or accuracy. If the generated data does not meet the specified performance threshold value, i.e. the quality is insufficient, it is generated anew. This means that the data generator makes another attempt to create improved versions of the ground truth data samples that correspond to the same ground truth source data. The newly generated data then preferably replace the original data that did not meet the quality standard. This step ensures that only data of acceptable quality are used for further training. The data generator can also, but purely optionally, be trained with the improved, i.e. the replaced and originally provided, ground truth data samples. This iterative process of evaluating, improving and, if necessary, training promotes the development of a more effective and more precise data generator. The statements made for the method apply accordingly to the apparatus. It goes without saying that any linguistic variations of features formulated in accordance with the method can be reformulated for the apparatus in accordance with standard linguistic practice, without such formulations having to be explicitly listed here.

In principle, the target machine learning model can be configured to solve a wide variety of tasks for which it can be trained using the generated data. The actual configuration of the target machine learning model can vary for each inference case.

The method provides an approach for ensuring the quality of AI-generated training data without compromising the efficiency and/or scalability of the creation process. This overcomes the limitations of conventional data production and ensures the integrity of the training data. The present method can distinguish good from bad synthetic ground truth data without human input or any other discriminator. This allows a machine learning model, such as a neural network, to be trained in a robust manner. The performance of the machine learning model is improved.

The term “ground truth sample data” describes an input for the machine learning model to be trained. Input can, for example, be image and/or video data, text data, audio data or the like.

The term “ground truth target data” describes an expected output of the machine learning model to be trained, for example a visible object and/or a visible subject, for instance a human skeleton, in an image or video file, a word or sequence of words in a text file, a sound or sequence of sounds in an audio file, etc.

The term “synthetic ground truth source data” describes the input of a generator, which uses them to generate consistent synthetic ground truth data samples. The synthetic ground truth source data include at least the ground truth target data, but additional inputs may be preferred. The generator can process a depth map of an image scene as an additional input in addition to the object and/or the subject, for example. This distinction is preferred because the generator provides the ability to generate any number of synthetic ground truth data samples, all of which share the same synthetic ground truth source data, and thus also the associated ground truth target data.

The present method is based on the insight that the machine learning model to be trained is itself a type of discriminator. Using an object detector as an example, poor recognition of a sample can be attributed either to poor performance of the machine learning model underlying the object detector or to a faulty synthetic ground truth sample. The method according to the present invention makes it possible to react to poor recognition or to an output that deviates from the ground truth target by replacing the synthesized ground truth sample in the training data set with multiple, new synthesized samples with the same precondition or ground truth source. This makes what exactly led to the poor performance unimportant. If the synthesized sample was poor, it can be replaced with the present method. On the other hand, if the performance of the machine learning model was poor, in particular in the specific situation, the replacement with multiple new samples enriches the training data set with exactly the type of data material that the machine learning model is still having trouble with. Pinpointing the exact cause of the underlying problem thus becomes irrelevant.

In another aspect of the present invention, providing ground truth data samples which relate to ground truth source data and are synthetically generated by the data generator comprises:
providing ground truth source data, in particular comprising depth maps and skeletal pose images;
generating ground truth data samples from the provided ground truth source data by means of the data generator, in particular a Stable Diffusion ControlNet, to synthesize consistent data;
preferably pretraining the target machine learning model with the generated ground truth data samples.

According to an example embodiment of the present invention, the method preferably includes providing ground truth source data that focus in particular on depth maps and skeletal pose images. Depth maps provide spatial information about the distances of objects in the scene to the camera, while skeletal pose images visualize the positioning and orientation of human or animal figures in the scene. These specific types of data are particularly valuable for applications that require spatial understanding and analysis of body postures. Based on the provided source data, the data generator creates synthetic ground truth data samples. This process is preferably carried out by a specialized type of data generator, specifically a Stable Diffusion Controlnet. This type of network is geared toward synthesizing consistent and high-quality data by utilizing advanced artificial intelligence and machine learning techniques. The focus on consistency means that the created data should match the source data in terms of the visual and spatial properties. Before the data generator begins the iterative process of evaluation and improvement, it can preferably be pretrained with the already generated ground truth data samples. However, this is purely optional. This step preferably serves to establish a basic performance capability of the data generator by training it on an initial data set. Pretraining helps to improve the efficiency of the subsequent iterative training process by ensuring that the data generator has already acquired a certain understanding of and adaptation to the characteristics of the ground truth data.

According to an example embodiment of the present invention, the data generator is preferably configured to use ground truth source data to generate synthetic ground truth data samples, which may be defective. Using image processing as an example, the data generator can be a “Stable Diffusion ControlNet”. For instance, the data generator can use depth maps and skeletal pose images that serve as the ground truth source to synthesize consistent images that form the ground truth sample. During the training of the data generator then, preferably after pretraining, ground truth data samples that exhibit poor performance, i.e. for which the data generator has a performance that is below the performance threshold value, are replaced as described with newly generated ground truth data samples.

In another aspect of the present invention, the method further comprises comparing a performance of the ground truth data samples with a median of the performance of all ground truth data samples for the same ground truth source, in particular to identify defective samples.

The comparison of the performance with the median is used to check the performance of individual ground truth data samples not only against a fixed performance threshold value, but also in comparison with the median of the performance of all ground truth data samples for the same ground truth source. The median serves here as a representative value of the central tendency of all generated data which is robust to outliers and provides a balanced measure of the overall data quality. The reason for this comparative approach is to identify defective or substandard ground truth data samples. Defective samples are preferably those the performance characteristics of which deviate significantly from the median, which is indicative of problems with data quality or consistency. These could preferably have been caused by errors in the generation process, inadequacies in the source data or other disruptions. By identifying defective or problematic data, the method enables a targeted improvement of the data quality and consistency. The comparison with the median of the performance of all samples introduces a more differentiated and more dynamic criterion for the evaluation of the data quality than a fixed performance threshold value alone could provide. This approach helps to further increase the effectiveness and accuracy of the data generator by specifically addressing the elements most needed for improvement.

In another aspect of the present invention, generating anew ground truth data samples is based on the deviation of their performance from the median of all ground truth data samples of the respective ground truth source.

The strategy of resampling can be further improved in a variety of ways. For instance, if there are already a sufficient number of ground truth data samples with the same ground truth source in the provided data set of (initial) ground truth data samples, comparing the performance of the data generator makes it possible to infer whether a ground truth sample is defective. In this case, the performance of defective ground truth data samples deviates significantly from the median of all ground truth data samples, whereas, for the ground truth source data, a generally poor performance of the data generator means that all of the ground truth data samples are equally poor.

According to an example embodiment of the present invention, the method includes analyzing how much the performance of an individual ground truth data sample deviates from the median value of the performance of all samples for the same ground truth source. This evaluation allows the quality of every sample to be precisely assessed and specifically identifies those that perform below average in relation to the specified performance standard. The decision to generate anew ground truth data samples is preferably based directly on the observed deviation of their performance from the median. Samples that exhibit a significant negative deviation are preferably selected as candidates for renewed generation. This criterion preferably ensures that the focus is on improving data quality by specifically addressing samples that can be improved the most relative to their peers. Generating anew ground truth data samples based on their relative performance deviation preferably makes it possible to effectively address specific problems or deficiencies in the data. This methodological approach aims to increase the overall quality of the data set by ensuring that all samples have a consistent level of performance that is closely aligned with the median of the overall sample group. Because of the preferable use of the median of the performance as the standard of comparison, the method dynamically adapts to the changing quality of the data set. This means that, as the average data quality improves, the requirements for each individual sample increase as well, which leads to a continuous improvement of the data quality over time.

In another aspect of the present invention, a number of the newly generated ground truth data samples is selected in proportion to the median of the performance of all synthetic ground truth data samples of the respective ground truth source, in particular to prevent overfitting and/or promote consistent network performance across all ground truth target data.

According to an example embodiment of the present invention, instead of replacing a ground truth sample with a defined number of new samples, the number of ground truth data samples can also be selected in proportion to the median of the performance of all synthetic ground truth data samples of the respective ground truth source data. This procedure in particular prevents overfitting and helps to achieve a similar performance of the data generator for all ground truth target data.

According to an example embodiment of the present invention, the number of newly generated ground truth data samples is in particular selected such that it is proportional to the median of the performance of all synthetic ground truth data samples. This means in particular that the decision on how much data to generate anew is based on the average quality of the current data set. A higher quality median can in particular lead to fewer renewed generations, while a lower median suggests a greater number of renewed generations. Proportionally adapting the number of newly generated samples to the median of the data quality in particular implements a mechanism that counteracts overfitting. Overfitting occurs when a model is too specifically tailored to the training data and thus loses its ability to generalize to new, unknown data. Adapting the number of samples to be generated anew with the objective of ensuring consistent quality across different ground truth target data, in particular promotes stable and predictable performance of the network. Balancing the data quality and the data volume ensures that the network is not affected by fluctuations in the data quality, which leads to more consistent and reliable performance. Similar to previous aspects, this approach enables dynamic adaptation of the training strategy based on the changing quality of the data.

In another aspect of the present invention, replacing ground truth data samples with poor performance is carried out by automatically identifying poor samples and generating anew ground truth data samples without manual intervention.

According to an example embodiment of the present invention, the process preferably starts with the automatic detection of ground truth data samples the performance of which is below a defined threshold value or compared to a performance median. This step uses algorithms and evaluation criteria to efficiently identify data that does not meet the quality requirements. Automating this step increases the objectivity and speed with which poor samples can be identified. After identification, the ground truth data samples deemed inadequate are preferably generated anew automatically without the need for manual intervention. This process includes the renewed use of the data generator to create improved versions of the data in question. The automatically newly generated ground truth data samples preferably replace those with poor performance in the database without the need for manual intervention.

In another aspect of the present invention, the method further comprises: limiting a number of ground truth data samples per ground truth source to prevent poor performance of all samples of a ground truth source due to systematic reasons and thus in particular avoid bloating of the training data.

In this preferred additional step, the number of ground truth data samples which relate to the same ground truth source is limited in order prevent poor performance of the data generator on all ground truth data samples of a ground truth source due to systematic reasons from bloating the data set. Because, in this case, the problem is not in the data synthesis nor in the convergence of training the target machine learning model. Instead, it is necessary to investigate whether the ground truth source is faulty and/or whether the network structure of the target machine learning model possibly has weaknesses.

According to an example embodiment of the present invention, a fixed upper limit for the number of ground truth data samples generated from a single ground truth source is preferably implemented. This limitation is preferably intended to prevent the database from being dominated by an excessive number of samples from individual sources, which could compromise the diversity and generalizability of the training data set. Limiting the number of samples per source reduces the risk that systematic errors or limitations of a specific source will lead to consistently poor performance across all associated samples. Such systematic problems could result from inferior quality source data, for example, or from inherent limitations of the data generation method. This also avoids bloating of the training data set. Too much data, especially if it is of limited diversity, can slow training and reduce the efficiency of the learning process without necessarily improving model performance.

In another aspect of the present invention, a computer program comprising program code for carrying out at least parts of the present method in one of its aspects when the computer program is executed on a computer is claimed. In other words, a computer program (product) comprising instructions that, when the program is executed by a computer, cause said computer to carry out the method/the steps of the method in one of its aspects is claimed.

In another aspect of the present invention, a computer-readable data carrier comprising program code of a computer program for carrying out at least parts of the present method in one of its aspects when the computer program is executed on a computer is proposed. In other words, the invention relates to a computer-readable (storage) medium comprising instructions which, when executed by a computer, cause said computer to carry out the method/the steps of the method in one of its aspects.

The described embodiments and further developments of the present invention can be combined with one another as desired.

Other possible embodiments, further developments and implementations of the present invention also include not explicitly mentioned combinations of features of the present invention described above or in the following with respect to embodiment examples.

### BRIEF DESCRIPTION OF THE DRAWINGS

The figures are intended to provide a better understanding of the example embodiments of the present invention. They illustrate example embodiments and, in connection with the description, serve to explain principles and concepts of the present invention.

Other embodiments and many of the mentioned advantages will emerge with reference to the figures. The shown elements of the figures are not necessarily drawn to scale with respect to one another.

FIG. 1 shows a schematic flow chart of one aspect of the present method.

FIG. 2 shows a schematic block diagram of one aspect of the present method.

### DETAILED DESCRIPTION OF EXAMPLE EMBODIMENTS

In the figures, the same reference signs refer to the same or functionally identical elements parts or components unless stated otherwise.

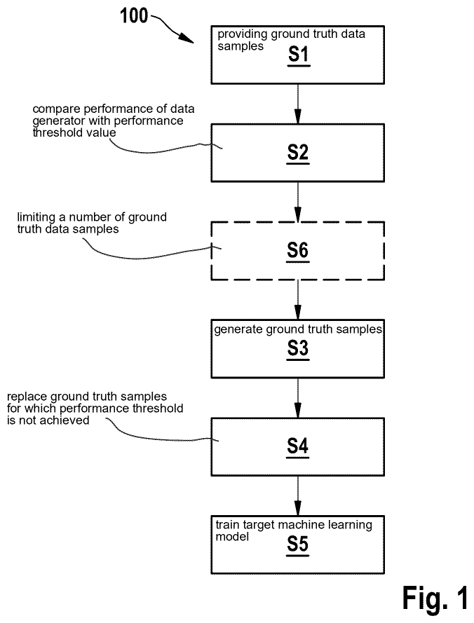

FIG. 1 shows a schematic flow chart of a method for improving synthetic ground truth data by means a data generator and for training a target machine learning model.

In any embodiment, the method can be carried out at least in part by an apparatus 100, which for this purpose can comprise a plurality of components not shown in detail, for example one or more providing devices and/or at least one evaluation and computing device. It goes without saying that the providing device can be configured jointly with the evaluation and computing device or can be different from it. The apparatus 100, which can be a part of a system, can also comprise a storage device and/or an output device and/or a display device and/or an input device.

The computer-implemented method comprises at least the following steps:

In a step S1, ground truth data samples are provided, which relate to ground truth source data and are synthetically generated by the data generator.

In a step S2, a performance of the data generator for the provided ground truth data samples is compared with a performance threshold value.

In a step S3, ground truth data samples for the same ground truth source data are generated anew by means of the data generator if the performance threshold value for the provided ground truth data samples is not achieved.

In a step S4, the ground truth data samples for which the performance threshold value is not achieved are replaced with the newly generated ground truth data samples.

In a step S5, the target machine learning model are trained on the basis of the replaced and provided ground truth data samples.

The method can optionally comprise step S6, specifically limiting a number of ground truth data samples per ground truth source to prevent poor performance of all samples of a ground truth source due to systematic reasons and thus in particular avoid bloating of the training data. This step is preferably carried out after step S2 and before step S3.

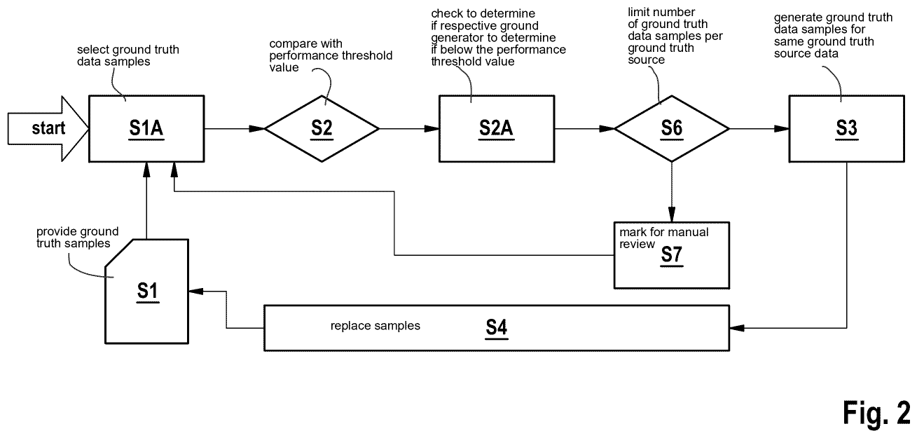

FIG. 2 shows a schematic block diagram of one aspect of the present method. The figure shows the providing S1 of ground truth data samples which relate to ground truth source data and are synthetically generated by the data generator. The provided ground truth data samples form a pool of ground truth data samples. Ground truth data samples are preferably selected from the pool of ground truth data samples in an optional step S1A. The further steps are carried out using the selected or thus provided ground truth data samples.

The performance of the data generator for the ground truth data samples provided, or selected in step S1A, is compared S2 with a performance threshold value. The respective performance of the data generator for the respective ground truth data samples is checked S2A to determine whether it is below the performance threshold value.

After step S2 or S2A, a number of ground truth data samples per ground truth source is limited S6 to prevent poor performance of all samples of a ground truth source due to systematic reasons and thus in particular avoid bloating of the training data. The limitation is carried out by comparing whether a number of ground truth data samples that have the same ground truth source exceeds a predetermined or selectable limit value. It should be noted that, if the threshold value in the optional step S6 is exceeded, then the ground truth source can be marked for a manual review in a step S7.

Ground truth data samples for the same ground truth source data are then generated anew or synthesized S3 by means of the data generator if the performance threshold value for the provided ground truth data samples is not achieved. This is based on the same ground truth source data.

The ground truth data samples for which the performance threshold value is not achieved are furthermore replaced S4 with the newly generated ground truth data samples.

The ground truth data samples are replaced in the initial data pool of ground truth data samples. This revised pool of data can then be used to train the target machine learning model.

1-10. (canceled)

11. A method for improving synthetic ground truth data using a data generator and for training a target machine learning model, wherein the method comprises the following steps:
providing ground truth data samples which relate to ground truth source data and are synthetically generated by the data generator;
comparing a performance of the data generator for the provided ground truth data samples with a performance threshold value;
generating anew ground truth data samples for the same ground truth source data using the data generator when the performance threshold value for the provided ground truth data samples is not achieved;
replacing the ground truth data samples for which the performance threshold value is not achieved with the newly generated ground truth data samples; and
training the target machine learning model based on the replaced and provided ground truth data samples.

12. The method according to claim 11, wherein the providing of the ground truth data samples which relate to the ground truth source data and are synthetically generated by the data generator includes:
providing the ground truth source data;
generating the ground truth data samples from the provided ground truth source data using the data generator to synthesize consistent data; and
pretraining the target machine learning model with the generated ground truth data samples.

13. The method according to claim 12, further comprising:
comparing a performance of the ground truth data samples with a median of a performance of all ground truth data samples for the same ground truth source.

14. The method according to claim 13, wherein the generating anew ground truth data samples is based on a deviation of a performance of the ground truth data samples from the median of all ground truth data samples of the same ground truth source.

15. The method according to claim 13, wherein a number of the newly generated ground truth data samples is selected in proportion to the median of the performance of all of ground truth data samples of the same ground truth source.

16. The method according to claim 11, wherein the replacing of the ground truth data samples for which the performance threshold value is not achieved is carried out by automatically identifying poor samples and generating anew ground truth data samples without manual intervention.

17. The method according to claim 11, further comprising:
limiting a number of ground truth data samples per ground truth source to prevent poor performance of all samples of a ground truth source due to systematic reasons.

18. A non-transitory computer-readable data carrier on which is stored program code of a computer program for improving synthetic ground truth data using a data generator and for training a target machine learning model, the program code, when executed by computer, causing the computer to perform the following steps:
providing ground truth data samples which relate to ground truth source data and are synthetically generated by the data generator;
comparing a performance of the data generator for the provided ground truth data samples with a performance threshold value;
generating anew ground truth data samples for the same ground truth source data using the data generator when the performance threshold value for the provided ground truth data samples is not achieved;
replacing the ground truth data samples for which the performance threshold value is not achieved with the newly generated ground truth data samples; and
training the target machine learning model based on the replaced and provided ground truth data samples.

19. An apparatus for improving synthetic ground truth data using a data generator and for training a target machine learning model, wherein the apparatus comprises an evaluation and computing device which is configured to carry out the following steps:
providing ground truth data samples which relate to ground truth source data and are synthetically generated by the data generator;
comparing a performance of the data generator for the provided ground truth data samples with a performance threshold value;
generating anew ground truth data samples for the same ground truth source data using the data generator when the performance threshold value for the provided ground truth data samples is not achieved;
replacing the ground truth data samples for which the performance threshold value is not achieved with the newly generated ground truth data samples; and
training the target machine learning model based on the replaced and provided ground truth data samples.
